(19) United States
(12) Patent Application Publication
(10) Pub. No.: US 2019/0152620 A1
(43) Pub. Date: May 23, 2019

(54) UNMANNED AERIAL VEHICLE, UNMANNED AERIAL VEHICLE CONTROL CENTER, AND UNMANNED AERIAL VEHICLE ALARM METHOD

(71) Applicant: Coretronic Intelligent Robotics Corporation, Hukou Township (TW)

(72) Inventors: YING-CHIEH CHEN, Hukou Township (TW); LIN-CHING WU, Hukou Township (TW); CHUANG-YUAN CHENG, Hukou Township (TW); KAI-CHUNG CHAN, Hukou Township (TW)

(21) Appl. No.: 16/172,682

(22) Filed: Oct. 26, 2018

(30) Foreign Application Priority Data
Oct. 27, 2017 (CN) 201711022147.0

(51) Int. Cl. B64D 45/00; B64C 39/02; G08B 21/18

(52) U.S. Cl. CPC B64D 45/00; B64C 39/024; G05D 1/0072; B64C 2201/14; G08B 21/182

(57) ABSTRACT

An unmanned aerial vehicle, an unmanned aerial vehicle control center and an unmanned aerial vehicle alarm method are provided. The unmanned aerial vehicle includes a motor and a control circuit board. The control circuit board is adapted to read a real-time drive current value and/or a real-time rotational speed value of the motor and transmitting warning related information. The unmanned aerial vehicle control center is adapted to conduct a warning according to the warning related information and adapted to a backup and storage of data. The unmanned aerial vehicle alarm method includes that the unmanned aerial vehicle is made to read the real-time drive current value and/or the real-time rotational speed value at the time of a motor operation and to transmit the warning related information to the unmanned aerial vehicle control center.

### CROSS-REFERENCE TO RELATED APPLICATION

THIS APPLICATION CLAIMS THE PRIORITY BENEFIT OF CHINA APPLICATION (CN201711022147.0 FILED ON 2017 Oct. 27). THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to an unmanned aerial vehicle alarm method for an unmanned aerial vehicle and an unmanned aerial vehicle control center, and more particularly to an unmanned aerial vehicle alarm method using a passive warning method and a proactive warning method for an unmanned aerial vehicle status warning.

### BACKGROUND OF THE INVENTION

The design focus of a current unmanned aerial vehicle (UAV) is to reduce the overall bulk weight of the unmanned aerial vehicle and increase its output horsepower to improve the endurance of the unmanned aerial vehicle. There is no related mechanism for both a motor running life and reliability of use. Thus it causes that the unmanned aerial vehicle needs to rely on human experience to determine whether a motor needs to be replaced and further results in that the chance of a crash of an unmanned aerial vehicle losing power or having insufficient power in the air increases greatly. The factors related to the decline of a motor include a noise, energy consumption and rotational speed, and these items are closely related with the life of a bearing. During the operation of the bearing, a lubricant will be volatilized because of heat. The metal of the bearing will begin to collide and the life of the bearing will be reduced. At this time, the energy consumption of the motor will be increased due to collision and vibration and the noise will be increased due to vibration. Under the vicious cycle, the motor will eventually not be able to provide enough rotational speed and a drone crash will occur. However, the data of the currents or rotational speed of the motor under different environments and loads still cannot be obtained by the existing mechanism, thus the status of a motor life cannot be effectively determined.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides an unmanned aerial vehicle, an unmanned aerial vehicle control center, and an unmanned aerial vehicle alarm method that can effectively predict an unmanned aerial vehicle motor life.

Other advantages and objects of the invention may be further illustrated by the technical features broadly embodied and described as follows.

In order to achieve one or a portion of or all of the objects or other objects, an unmanned aerial vehicle of the invention includes a motor and a control circuit board. The control circuit board further includes a monitoring unit, a control circuit communication module and a control circuit processor. The monitoring unit is electrically connected with the motor and is adapted to read a real-time drive current value and/or a real-time rotational speed value generated by motor operation. The control circuit communication module is adapted to transmit warning related information to an external unmanned aerial vehicle control center. The control circuit processor is electrically connected with the monitoring unit and the control circuit communication module and is adapted to receive the required information such as the real-time drive current value and/or the real-time rotational speed value, and conduct a data exchange and computation.

In order to achieve one or a portion of or all of the objects or other objects, an unmanned aerial vehicle control center of the invention includes a control center communication module, a control center processor and a control center alarm module. The control center communication module is adapted to receive warning related information transmitted by an unmanned aerial vehicle. The warning related information is transmitted to the control center processor. The control center processor is electrically connected with the control center communication module and is adapted to conduct a data exchange and computation of the received data such as the warning related information. The control center alarm module is electrically connected with the control center processor and is adapted to receive a warning control signal and performing a corresponding operation according to the warning control signal to conduct a warning.

In order to achieve one or a portion of or all of the objects or other objects, an unmanned aerial vehicle alarm method of the invention includes the following steps: configuring an unmanned aerial vehicle to read a real-time current value and/or a real-time rotational speed value of a motor and to transmit warning related information to an unmanned aerial vehicle control center; and configuring the unmanned aerial vehicle control center to configure a control center alarm module to conduct a warning according to a warning control signal.

In the invention, an alarm module is configured to conduct a warning by a real-time current value and/or a real-time rotational speed value of a motor of an unmanned aerial vehicle being read and according to a warning control signal corresponding to the real-time current value and/or the real-time rotational speed value. Therefore, the user can perform maintenance or replacement of the motor earlier. Not only can a motor life be effectively extended, but also the cases of a crash of the unmanned aerial vehicle because of a motor failure can further be effectively reduced.

Other objectives, features and advantages of The invention will be further understood from the further technological features disclosed by the embodiments of The invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a first embodiment of an unmanned aerial vehicle control system of the invention;

FIG. 1B is a second embodiment of an unmanned aerial vehicle control system of the invention;

FIG. 1C is a third embodiment of an unmanned aerial vehicle control system of the invention;

FIG. 2A is a first embodiment of a system of an unmanned aerial vehicle of the invention;

FIG. 2B is a second embodiment of a system of an unmanned aerial vehicle of the invention;

FIG. 2C is a third embodiment of a system of an unmanned aerial vehicle of the invention;

FIG. 3A is a first embodiment of a system of an unmanned aerial vehicle control center of the invention;

FIG. 3B is a second embodiment of a system of an unmanned aerial vehicle control center of the invention;

FIG. 4A is an embodiment of an unmanned aerial vehicle alarm method of the invention;

FIG. 4B is an embodiment of an unmanned aerial vehicle passive warning method of the invention;

FIG. 4C is a first embodiment of an unmanned aerial vehicle proactive warning method of the invention; and

FIG. 4D is a second embodiment of an unmanned aerial vehicle alarm method of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

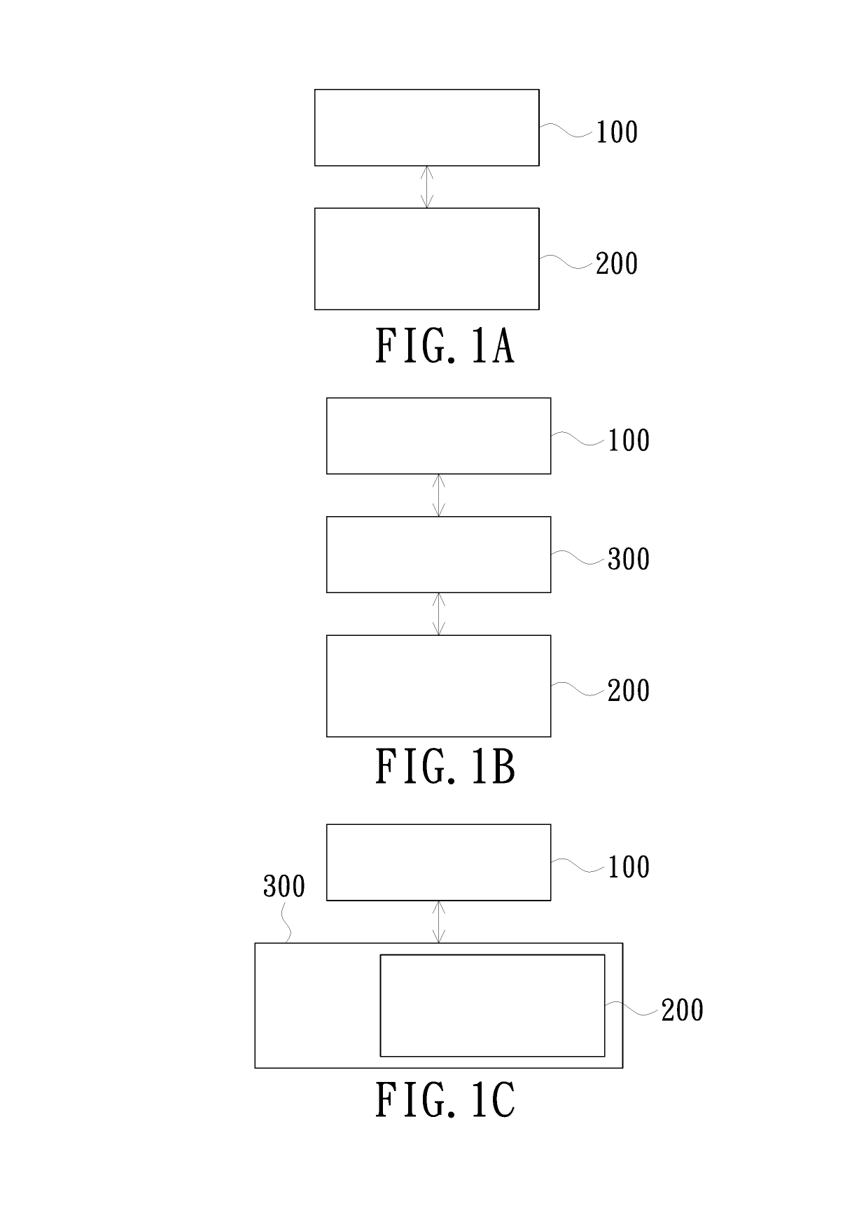

Please refer to FIG. 1A. FIG. 1A is a first embodiment of an unmanned aerial vehicle control system. In the embodiment, the unmanned aerial vehicle control system includes an unmanned aerial vehicle 100 and an unmanned aerial vehicle control center 200. The unmanned aerial vehicle 100 and the unmanned aerial vehicle control center 200 are electrically connected to each other and may communicate with each other and exchange data in a wired or wireless manner. Please refer to FIG. 1B. FIG. 1B is a second embodiment of an unmanned aerial vehicle control system. Since the unmanned aerial vehicle 100 can park on a parking apron 300 when not flying, the parking apron 300 can charge and provide shelter for the unmanned aerial vehicle 100. In the embodiment, the unmanned aerial vehicle control system may include an unmanned aerial vehicle 100, an unmanned aerial vehicle control center 200, and a parking apron 300. The unmanned aerial vehicle 100 communicates with the parking apron 300 in a wired or wireless manner The unmanned aerial vehicle control center 200 communicates with the parking apron 300 in a wireless or wired manner. Therefore, when the unmanned aerial vehicle 100 is charged on the parking apron 300, the relevant data during the operation of the unmanned aerial vehicle 100 can be transmitted to the unmanned aerial vehicle control center 200 through the parking apron 300. The unmanned aerial vehicle control center 200 may be implemented as a smart mobile device, a laptop or an unmanned aerial vehicle center console, but not limited thereto. In other embodiments, the unmanned aerial vehicle control center 200 may also be disposed on the parking apron 300 and communicate with the unmanned aerial vehicle 100 in a wired or wireless manner, as shown in FIG. 1C.

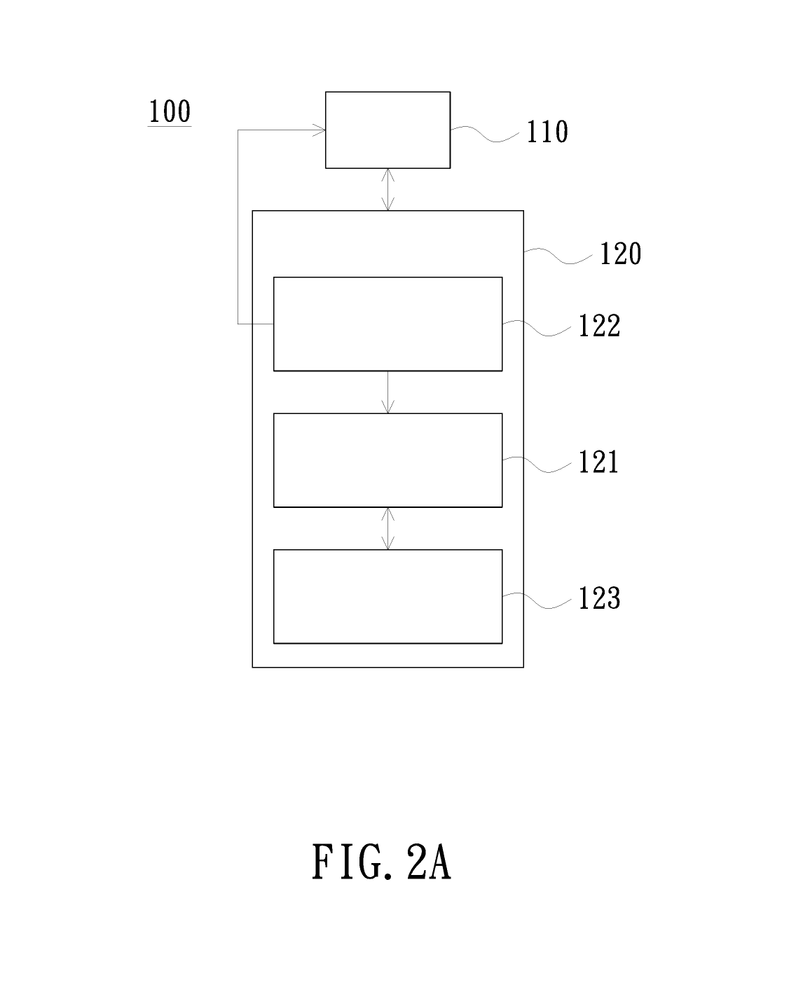

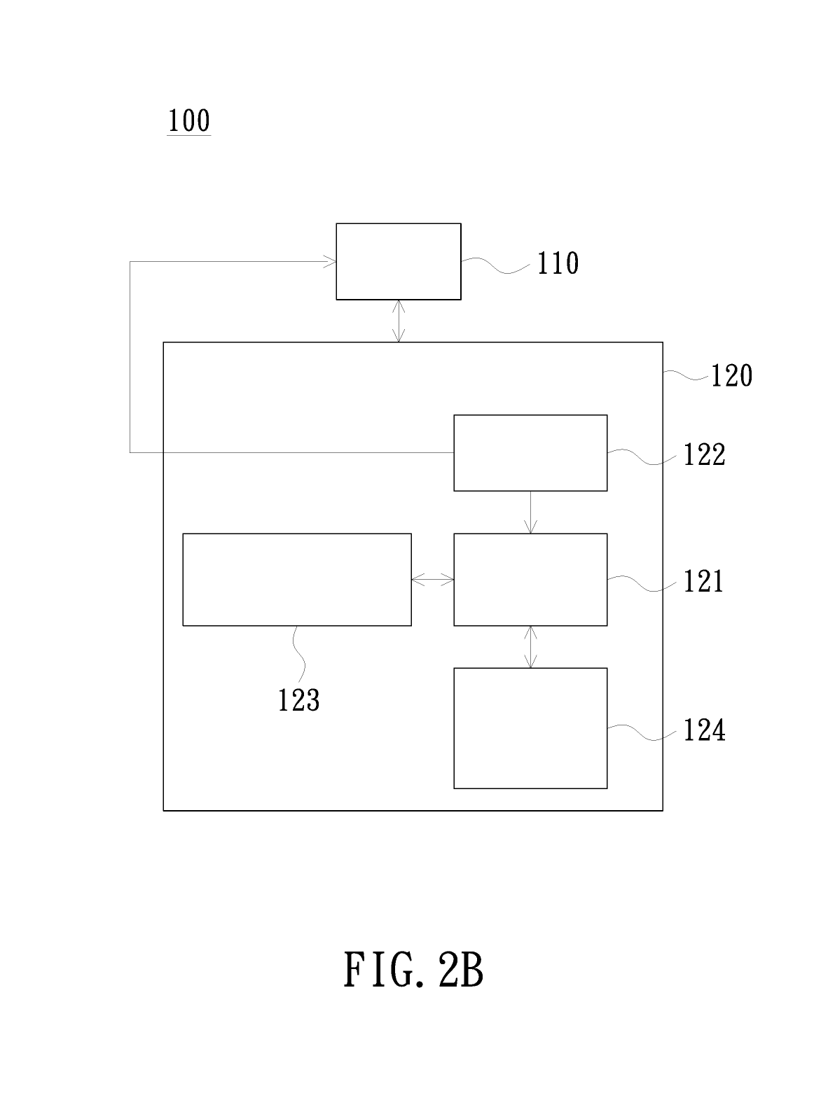

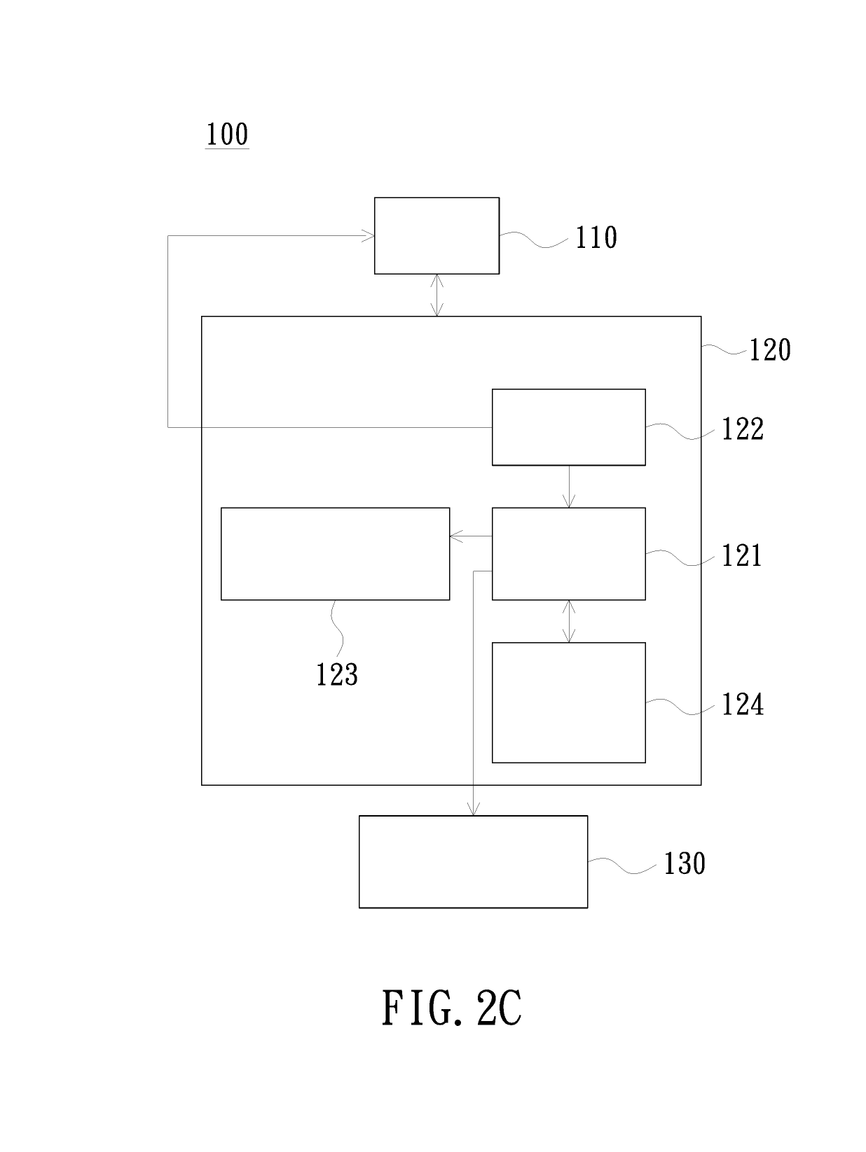

Then, please refer to FIG. 2A, FIG. 2B and FIG. 2C. FIG. 2A, FIG. 2B and FIG. 2C are schematic diagrams of a system of an unmanned aerial vehicle 100 of an embodiment. FIG. 2A is a first embodiment of a system of an unmanned aerial vehicle 100. In the embodiment, the unmanned aerial vehicle 100 includes a motor 110 and a control circuit board 120. The motor 110 is for providing the lift needed for the unmanned aerial vehicle 100 to take off. The main function of the control circuit board 120 is to control the operation of the motor 110. The control circuit board 120 has a monitoring unit to read the real-time drive current value and real-time rotational speed value of the motor 110. The control circuit board 120 is adapted to transmit the warning related information to an external unmanned aerial vehicle control center 200 (FIGS. 1A, 1B and 1C) so that the unmanned aerial vehicle control center 200 can conduct a warning according to the warning related information.

In the embodiment, the control circuit board 120 includes a control circuit processor 121, a monitoring unit 122, and a control circuit communication module 123. The monitoring unit 122 is electrically connected with the motor 110 and the control circuit processor 121. The monitoring unit 122 is, for example, a three-phase current detection circuit and a rotational speed detector, but not limited thereto. The monitoring unit 122 is adapted to read the real-time drive current value and/or the real-time rotational speed value generated by the motor 110 during operation in real time. The read real-time drive current value and/or the real-time rotational speed value are transmitted to the control circuit processor 121 for subsequent computation and exchange. The control circuit processor 121 generates the warning related information according to the received real-time drive current value and/or the real-time rotational speed value, that is, the warning related information includes at least one of the real-time drive current value and the real-time rotational speed value and the time when the real-time drive current value and/or the real-time rotational speed value are generated. The control circuit processor 121 transmits the warning related information to the control circuit communication module 123. The control circuit communication module 123 is electrically connected with the control circuit processor 121 and is adapted to receive the warning related information and transmit the warning related information to the external unmanned aerial vehicle control center 200. The control circuit communication module 123 is, for example, a Wi-Fi wireless communication module, a third generation (3G) communication module, a fourth generation (4G) communication module and/or a universal serial bus module (USB), etc., but not limited thereto.

Please refer to FIG. 2B. FIG. 2B is a second embodiment of a system of an unmanned aerial vehicle 100. The difference between FIG. 2B and FIG. 2A is that the control circuit board 120 in FIG. 2B further includes a control circuit storage module 124 electrically connected with the control circuit processor 121. The control circuit storage module 124 may be a storage card or a memory, but not limited thereto. So during the operation of the motor 110, the real-time drive current value and/or the real-time rotational speed value read by the monitoring unit 122 and their corresponding time are continuously stored in the control circuit storage module 124 through the control circuit processor 121.

In some embodiments, the control circuit storage module 124 further stores a motor information database. The motor information database includes a motor initial rotational speed value and a plurality of rotational speed values generated by the motor 110 at different operations, and/or a motor initial drive current value and a plurality of drive current values generated by the motor 110 at different operations. The motor initial rotational speed value is a first record of rotational speed value generated by the motor 110 during initial operation and the motor initial drive current value is a first record of drive current value generated by the motor 110 during initial operation. The motor information database can be obtained through an experiment or a reliability test. The reliability test is, for example, the rotational speed value obtained when the motor 110 is at different operations at a fixed input current and the amount of change in the input current required when the motor 110 is at different operations at a fixed rotational speed value, etc., but not limited thereto. The motor 110 will increase its driving current to maintain the required rotational speed or generate a rotational speed lower than the motor initial rotational speed value under the same driving current with the extension of operational time, the change of the ambient temperature and other reasons. Therefore, the status of the motor 110 can be accurately determined by comparing the real-time drive current value and the real-time rotational speed value with the plurality of rotational speed values and the plurality of drive current values recorded in the motor information database and the life of the motor 110 can be effectively evaluated.

Please refer to FIG. 2C. FIG. 2C is a third embodiment of a system of an unmanned aerial vehicle 100. The difference between FIG. 2C and FIG. 2B is that the unmanned aerial vehicle 100 of FIG. 2C further includes an unmanned aerial vehicle alarm module 130. The unmanned aerial vehicle alarm module 130 is electrically connected with the control circuit board 120 and is adapted to receive an unmanned aerial vehicle warning control signal generated by the control circuit processor 121 and perform a corresponding operation according to the unmanned aerial vehicle warning control signal. The unmanned aerial vehicle alarm module 130 is a light-emitting device and/or an audio playback device so that lights and warning sounds of different frequencies and/or colors and other means can be used to conduct a warning by the unmanned aerial vehicle 100.

Therefore, in the embodiments of FIG. 2B and FIG. 2C, the control circuit processor 121 can determine whether to generate an external warning control signal and/or an unmanned aerial vehicle warning control signal according to the real-time drive current value and/or the real-time rotational speed value received in real time in flight and the motor information database. The control circuit processor 121 generates warning related information according to the external warning control signal and/or the unmanned aerial vehicle warning control signal. In the embodiment, the warning related information includes the external warning control signal, the real-time drive current value and/or the real-time rotational speed value. The control circuit processor 121 determines whether to generate the unmanned aerial vehicle warning control signal and/or the external warning control signal according to whether the real-time drive current value generated by the motor 110 at the same rotational speed value is greater than or equal to 120% of the motor initial drive current value and/or according to whether the real-time rotational speed value generated by the motor 110 at the same drive current value is less than 80% of the motor initial rotational speed value. The control circuit processor 121 may, for example, compare whether the real-time drive current value is equal to or greater than one of the drive current values in the motor information database and this drive current value is greater than or equal to 120% of the motor initial drive current value. The control circuit processor 121 may, for example, compare whether the real-time rotational speed value is equal to or less than one of the rotational speed values in the motor information database and this rotational speed value is less than or equal to 80% of the motor initial rotational speed value.

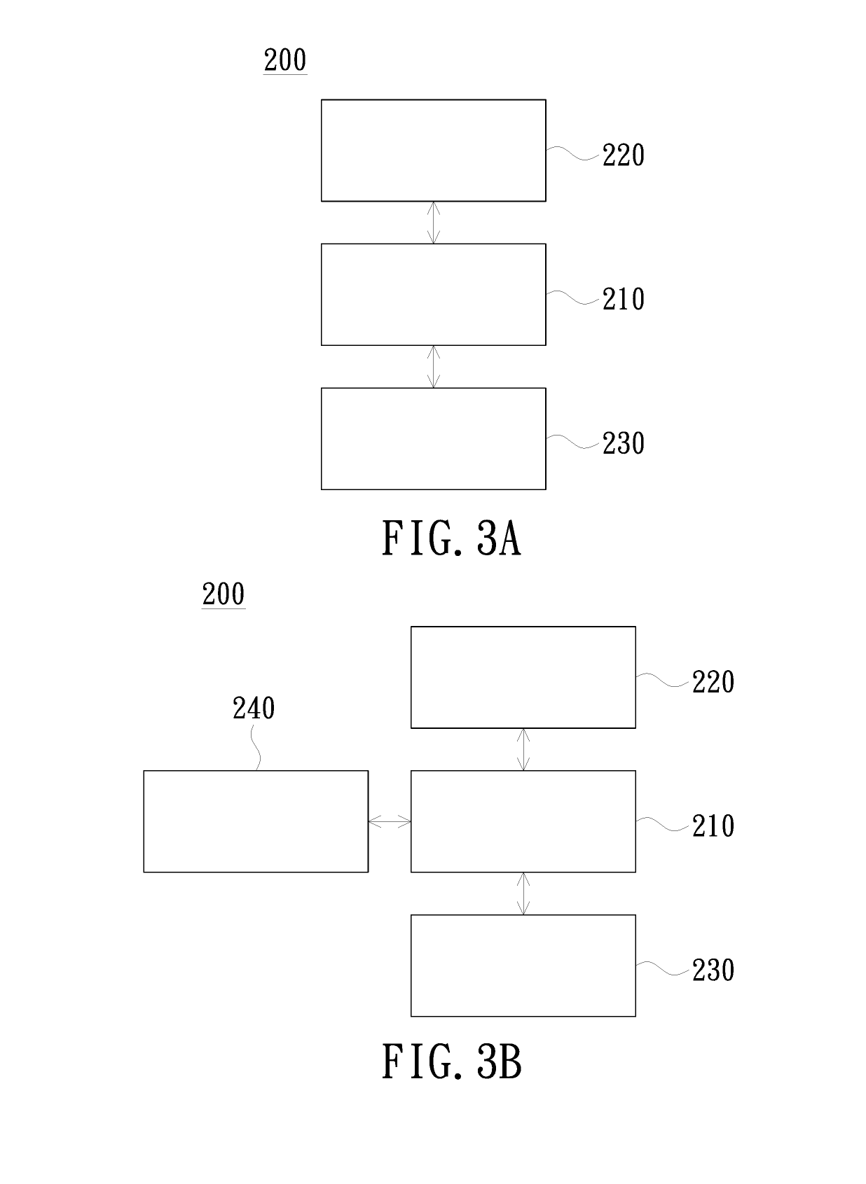

Please refer to FIG. 3A. FIG. 3A is a first embodiment of a system of an unmanned aerial vehicle control center 200. The unmanned aerial vehicle control center 200 includes a control center processor 210, a control center communication module 220, and a control center alarm module 230. The control center communication module 220 is, for example, a Wi-Fi wireless communication module, a third generation communication module, a fourth generation communication module and/or a universal serial bus module, etc., but not limited thereto. The control center communication module 220 is electrically connected to the control center processor 210. The control center communication module 220 receives the warning related information transmitted by the unmanned aerial vehicle 100 in a wired or wireless communication manner and transmits the warning related information to the control center processor 210. Therefore, the control center processor 210 can conduct an exchange and computation for the received data. In the embodiment, the warning related information includes an external warning control signal. So the control center processor 210 can configure the control center alarm module 230 to operate according to the warning control signal generated according to the received warning related information. In the embodiment, the warning control signal is an external warning control signal. The control center alarm module 230 may be a light-emitting device, an audio playback device or a display equipment. Therefore, the control center alarm module 230 can conduct a warning by displaying lights of different frequencies and/or colors, playing a warning sound and/or displaying a warning message and other means according to the warning control signal.

Please refer to FIG. 3B. FIG. 3B is a second embodiment of a system of an unmanned aerial vehicle control center 200. The difference between FIG. 3B and FIG. 3A is that the embodiment of the system of the unmanned aerial vehicle control center 200 of FIG. 3B further includes a control center storage module 240. The control center storage module 240 may store the motor information database and may be implemented by a storage card or a memory. In the embodiment, in addition to the external warning control signal, the warning related information may further include a plurality of real-time drive current values and/or a plurality of real-time rotational speed values generated by the unmanned aerial vehicle in flight. Therefore, the real-time drive current value and/or the real-time rotational speed value can be stored in the control center storage module 240 for subsequent computation or backup.

Therefore, in the embodiment, in addition to configuring the control center alarm module 230 to operate according to the received external warning control signal, the control center processor 210 may further determine whether to generate the internal warning control signal according to the received real-time drive current value and/or the real-time rotational speed value. So in the embodiment, the warning control signal includes the external warning control signal and/or the internal warning control signal, so that the control center alarm module 230 performs the above operation according to the external warning control signal and/or the internal warning control signal in the warning control signal. That is, the control center processor 210 determines whether to generate the internal warning control signal according to whether the real-time drive current value at the same rotational speed is greater than or equal to 120% of the motor initial drive current value and/or according to whether the real-time rotational speed value at the same current is less than 80% of the motor initial rotational speed value.

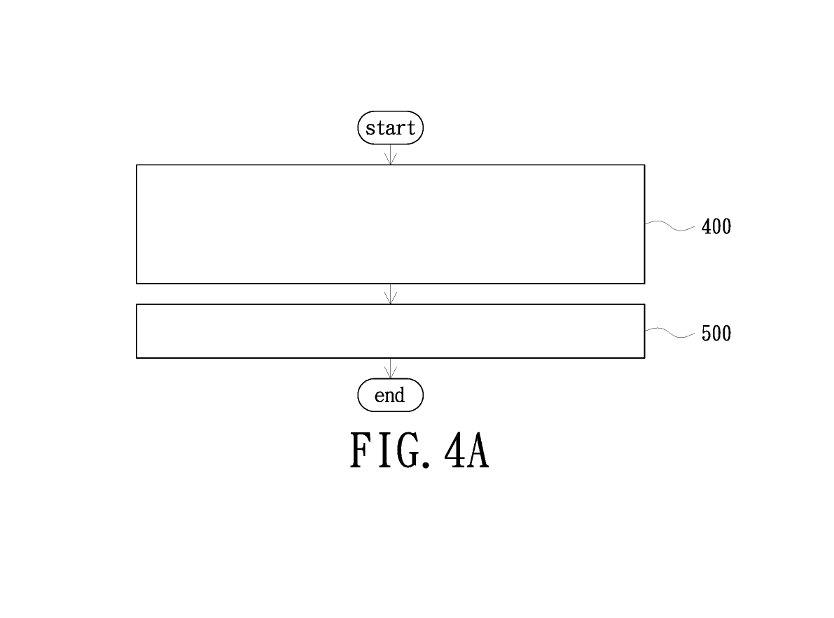

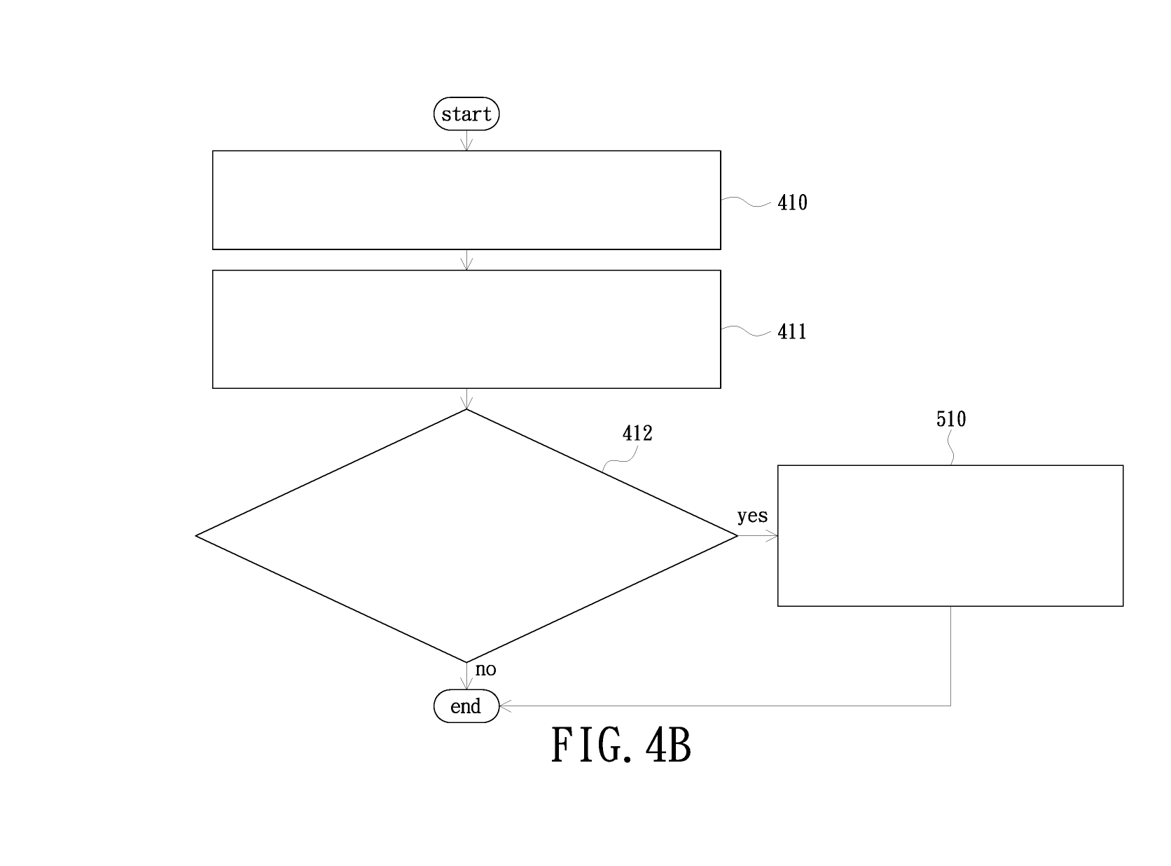

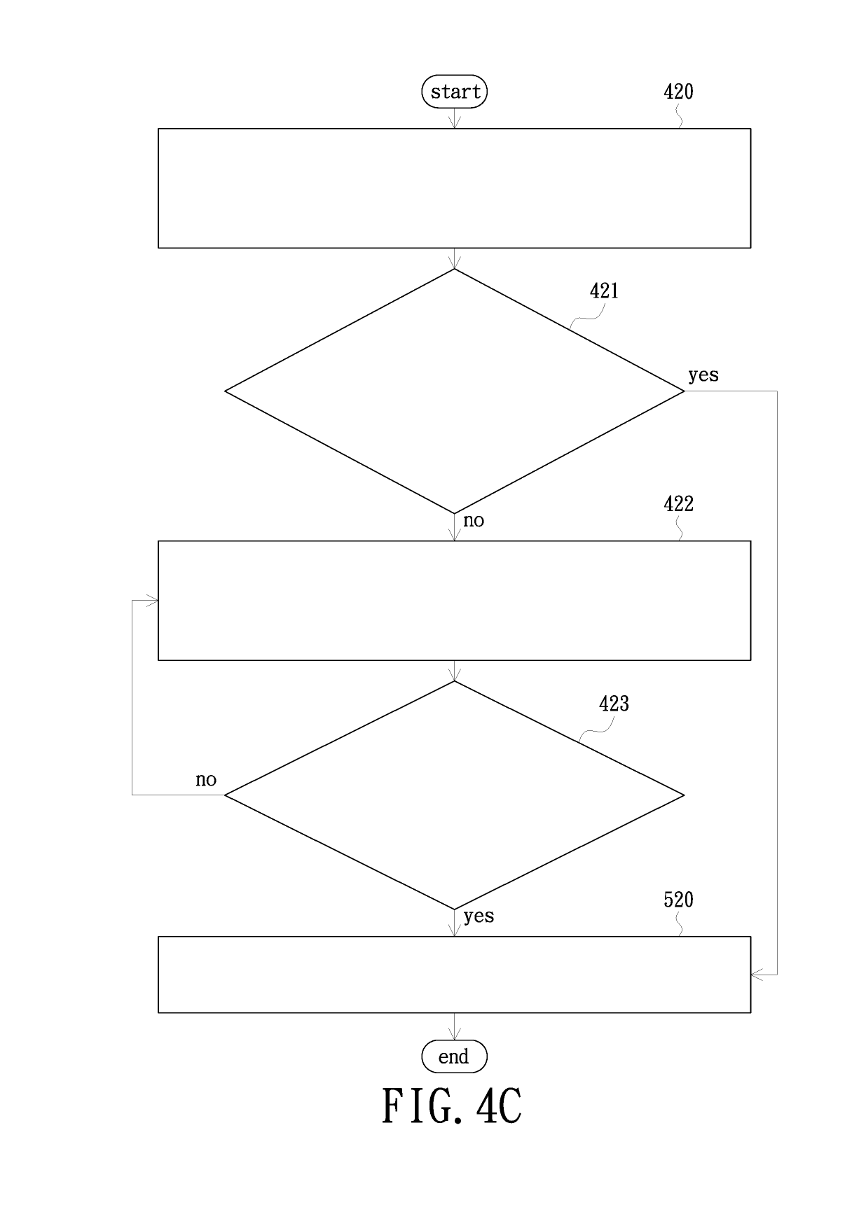

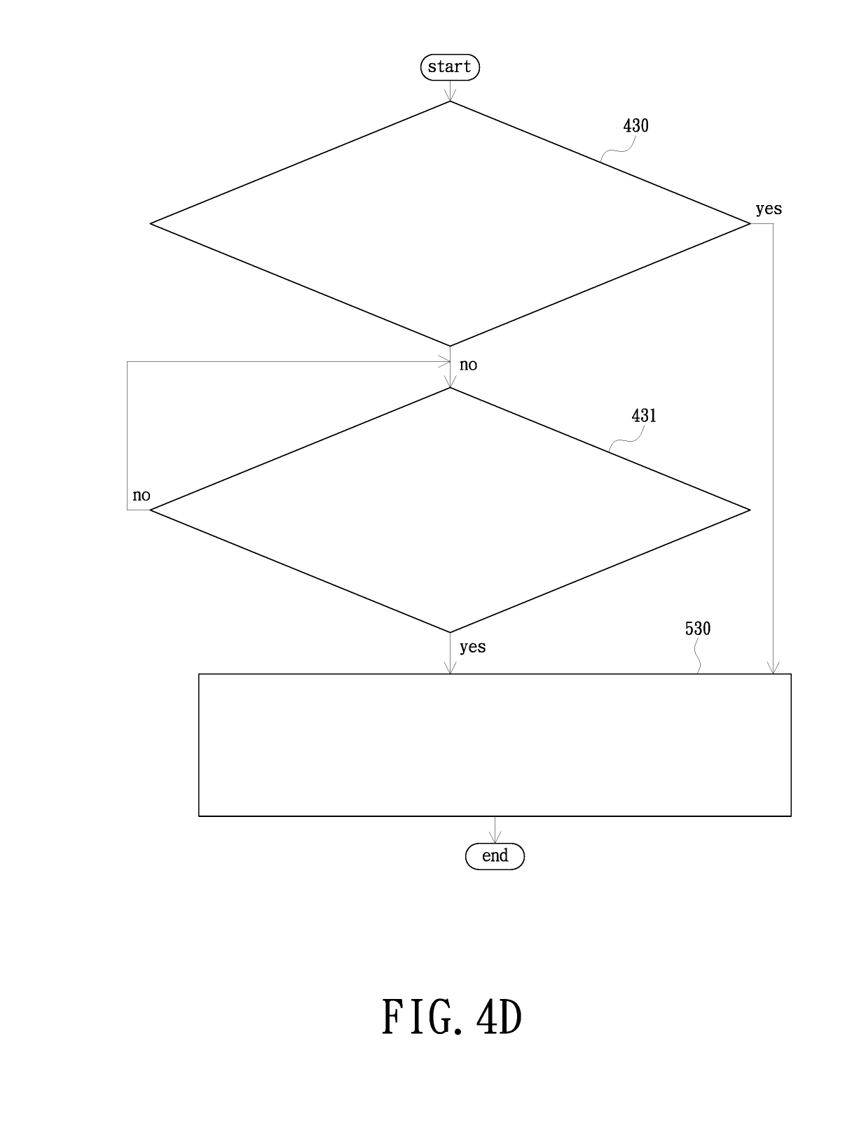

Please refer to FIG. 4A. FIG. 4A is an unmanned aerial vehicle alarm method of the invention. The method includes following steps. At step 400, configure the unmanned aerial vehicle 100 to read the real-time drive current value and/or the real-time rotational speed value of the motor 110 and to transmit the warning related information to the unmanned aerial vehicle control center 200. At step 500, configure the alarm module to conduct a warning according to the warning control signal. The following will further explain the embodiments of the operations of the unmanned aerial vehicle alarm method in different modes.

In some embodiments, the unmanned aerial vehicle alarm method can conduct a warning by the mode of a passive warning. Please refer to FIG. 2B, FIG. 3B and FIG. 4B concurrently. FIG. 4B is a schematic diagram of an embodiment of the passive warning of the unmanned aerial vehicle alarm method. In the embodiment, the step 400 further includes the following steps. At step 410, configure the unmanned aerial vehicle 100 in flight to continuously read and store a plurality of real-time drive current values and/or real-time rotational speed values generated by the motor 110 during operation. At step 411, when landing, the unmanned aerial vehicle 100 transmits the stored plurality of real-time drive current values and/or real-time rotational speed values as warning related information to the unmanned aerial vehicle control center 200. At step 412, the unmanned aerial vehicle control center 200 determines whether to generate an internal warning control signal as a warning control signal according to the received warning related information and the motor information database stored in the control center storage module 240. When the determination is yes, the current motor life of the unmanned aerial vehicle 100 has reached the standard of maintenance or replacement and it is not recommended to continue the flight and step 500 is performed. On the contrary, the unmanned aerial vehicle 100 is determined to be able to continue the next flight, thus the process is ended. In the embodiment, the step 500 further includes step 510. At step 510, configure the unmanned aerial vehicle control center 200 to configure the control center alarm module 230 to conduct a warning according to the internal warning control signal of step 412. Therefore, the user can know through a warning of the unmanned aerial vehicle control center 200 that the current life of the motor 110 of the unmanned aerial vehicle 100 has reached the standard of maintenance or replacement and repair or replace the motor 110 to avoid the case of a plane crash due to the damage of the motor 110 for the next flight of the unmanned aerial vehicle 100. The step 412 further includes that the unmanned aerial vehicle control center generates an internal warning control signal when one of the real-time drive current values at the same rotational speed is greater than or equal to 120% of the motor initial drive current value and/or when one of the real-time rotational speed values is less than or equal to 80% of the motor initial rotational speed value.

In some embodiments, the unmanned aerial vehicle alarm method can conduct a warning by the mode of a proactive warning. Please refer to FIG. 2A, FIG. 3B and FIG. 4C concurrently. FIG. 4C is a schematic diagram of an embodiment of the proactive warning of the unmanned aerial vehicle alarm method. The step 400 further includes following steps. At step 420, configure the unmanned aerial vehicle 100 to read the real-time drive current value and the real-time rotational speed value of the motor 110 when taking off and hovering. The real-time drive current value and/or the real-time rotational speed value are transmitted as the warning related information to the unmanned aerial vehicle control center 200. At step 421, the unmanned aerial vehicle control center 200 determines whether to generate an internal warning control signal according to the warning related information and the motor information database stored in the control center storage module 240. When the determination is yes, the current motor life of the unmanned aerial vehicle 100 has reached the standard of maintenance/replacement and it is not recommended to continue the flight, thus step 500 is performed. On the contrary, step 422 is performed so that the unmanned aerial vehicle 100 can fly. At step 422, configure the unmanned aerial vehicle 100 in flight to continuously read the real-time drive current value and the real-time rotational speed value. The unmanned aerial vehicle 100 transmits the read real-time drive current value and/or the real-time rotational speed value as the warning related information to the unmanned aerial vehicle control center 200 and then step 423 is performed. At step 423, the unmanned aerial vehicle control center 200 determines in real time whether to generate an internal warning control signal according to the warning related information and the motor information database stored in the control center storage module 240. When the determination is yes, step 500 is performed. On the contrary, step 422 is performed and the unmanned aerial vehicle 100 continues to fly. In the embodiment, the step 500 further includes step 520. At step 520, configure the unmanned aerial vehicle control center 200 to configure the control center alarm module 230 to conduct a warning in the manner described above according to the internal warning control signal. The steps 421 and 423 further include that the unmanned aerial vehicle control center generates an internal warning control signal when the real-time drive current value at the same rotational speed is greater than or equal to 120% of the motor initial drive current value and/or when the real-time rotational speed value at the same current is less than or equal to 80% of the motor initial rotational speed value.

Please refer to FIG. 2C, FIG. 3B and FIG. 4D concurrently. FIG. 4D is a schematic diagram of a second embodiment of the proactive warning of the unmanned aerial vehicle alarm method. The step 400 further includes the following steps. At step 430, configure the unmanned aerial vehicle 100 to read the real-time drive current value and the real-time rotational speed value of the motor 110 when taking off and hovering, to compare the real-time drive current value and/or the real-time rotational speed value with the motor information database stored in the control circuit storage module 124 and to determine whether to generate an unmanned aerial vehicle warning control signal and/or an external warning control signal. When the determination is yes, the current motor life of the unmanned aerial vehicle 100 has reached the standard of maintenance/replacement and it is not recommended to continue the flight, thus step 500 is performed. On the contrary, step 431 is performed. The unmanned aerial vehicle 100 is configured to continue to fly. At step 431, configure the unmanned aerial vehicle 100 in flight to continuously read the real-time drive current value and the real-time rotational speed value and to compare the real-time drive current value and/or the real-time rotational speed value with the motor information database stored in the control circuit storage module 124 to determine in real time whether to generate an unmanned aerial vehicle warning control signal and/or an external warning control signal. When the determination is yes, the current motor life of the unmanned aerial vehicle 100 has reached the standard of maintenance/replacement and it is not recommended to continue the flight, thus step 500 is performed. On the contrary, step 431 is continued to be performed. The step 500 further includes step 530. At step 530, configure the unmanned aerial vehicle 100 to configure the unmanned aerial vehicle alarm module to conduct a warning according to the unmanned aerial vehicle warning control signal. In some embodiments of step 530, the unmanned aerial vehicle 100 further transmits the external warning control signal as the warning related information to the unmanned aerial vehicle control center 200. Configure the unmanned aerial vehicle control center 200 to configure the control center alarm module 230 to conduct a warning according to the external warning control signal. In other embodiments of step 530, the warning related information further includes the real-time drive current value and/or the real-time rotational speed value used to generate the external warning control signal. Thus, the real-time drive current value and/or the real-time rotational speed value may be backed up in the unmanned aerial vehicle control center 200. In addition, in other embodiments of FIG. 4D, the unmanned aerial vehicle 100 may further store the real-time drive current value and/or the real-time rotational speed value read in real time in the control circuit storage module 124 to facilitate subsequent backup, storage or computation of the data. The steps 430 and 431 further include that the unmanned aerial vehicle 100 generates an unmanned aerial vehicle warning control signal and/or an external warning control signal when the real-time drive current values at the same rotational speed are greater than or equal to 120% of the motor initial drive current value and/or when the real-time rotational speed values at the same current are less than or equal to 80% of the motor initial rotational speed value.

In summary, in the invention, whether to generate a warning control signal to configure an alarm module to conduct a warning is determined by reading the real-time current value and/or the real-time rotational speed value of the motor of the unmanned aerial vehicle and comparing the real-time current value and/or the real-time rotational speed value with the motor information database. Therefore, the user can determine the status of the motor life according to the state of the operation of the motor to perform maintenance or replacement of the motor earlier. In addition, when operating on the mode of the proactive warning, the status of the motor life is further determined when the unmanned aerial vehicle takes off and hovers. The effect of multiply monitoring the motor is achieved through a pre-flight detection. Not only can the motor life be effectively extended, but also the cases of a crash of the unmanned aerial vehicle because of a motor failure can further be effectively reduced.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “The invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An unmanned aerial vehicle, comprising:
a motor; and
a control circuit board, comprising:
a monitoring unit, electrically connected with the motor and adapted to read a real-time drive current value and/or a real-time rotational speed value of the motor;
a control circuit communication module, adapted to transmit warning related information to an external unmanned aerial vehicle control center; and
a control circuit processor, electrically connected with the monitoring unit and the control circuit communication module and adapted to conduct a data exchange and computation.

2. The unmanned aerial vehicle according to claim 1, wherein the warning related information comprises an external warning control signal, the real-time drive current value and/or the real-time rotational speed value.

3. The unmanned aerial vehicle according to claim 2, wherein the control circuit board comprises a control circuit storage module connected with the control circuit processor, and the control circuit storage module is adapted to store the real-time rotational speed value, the real-time drive current value and/or a motor information database.

4. The unmanned aerial vehicle according to claim 3, wherein the motor information database comprises a motor initial rotational speed value and a plurality of rotational speed values generated by the motor at different operations, and/or a motor initial drive current value and a plurality of drive current values generated by the motor at different operations.

5. The unmanned aerial vehicle according to claim 4, wherein the control circuit processor determines whether to generate an unmanned aerial vehicle warning control signal and/or the external warning control signal according to the real-time drive current value and/or the real-time rotational speed value.

6. The unmanned aerial vehicle according to claim 5, wherein the control circuit processor determines whether to generate the unmanned aerial vehicle warning control signal and/or the external warning control signal according to whether the real-time drive current value generated by the motor at the same rotational speed value is greater than or equal to 120% of the motor initial drive current value and/or according to whether the real-time rotational speed value generated by the motor at the same drive current value is less than 80% of the motor initial rotational speed value.

7. The unmanned aerial vehicle according to claim 6, further comprising an unmanned aerial vehicle alarm module, wherein the unmanned aerial vehicle alarm module is electrically connected with the control circuit processor and receives the unmanned aerial vehicle warning control signal, the unmanned aerial vehicle alarm module operates according to the unmanned aerial vehicle warning control signal, and the unmanned aerial vehicle alarm module is a light-emitting device and/or an audio playback device.

8. An unmanned aerial vehicle control center, comprising:
a control center communication module, adapted to receive warning related information of an unmanned aerial vehicle;
a control center processor; electrically connected with the control center communication module and adapted to conduct a data exchange and computation; and
a control center alarm module, electrically connected with the control center processor, receiving a warning control signal and operating according to the warning control signal.

9. The unmanned aerial vehicle control center according to claim 8, wherein the warning related information comprises an external warning control signal, a real-time drive current value and/or a real-time rotational speed value.

10. The unmanned aerial vehicle control center according to claim 9, wherein the warning control signal comprises an internal warning control signal and/or the external warning control signal.

11. The unmanned aerial vehicle control center according to claim 9, further comprising a control center storage module, wherein the control center storage module stores a motor information database of the unmanned aerial vehicle, the real-time rotational speed value and/or the real-time drive current value.

12. The unmanned aerial vehicle control center according to claim 11, wherein the motor information database comprises a motor initial rotational speed value and a plurality of rotational speed values generated by the motor at different operations, and/or a motor initial drive current value and a plurality of drive current values generated by the motor at different operations.

13. The unmanned aerial vehicle control center according to claim 12, wherein the control center processor is adapted to determine whether to generate the internal warning control signal according to the real-time drive current value and/or the real-time rotational speed value.

14. The unmanned aerial vehicle control center according to claim 13, wherein the control circuit processor determines whether to generate the internal warning control signal according to whether the real-time drive current value generated by the motor at the same rotational speed value is greater than or equal to 120% of the motor initial drive current value and/or according to whether the real-time rotational speed value generated by the motor at the same drive current value is less than or equal to 80% of the motor initial rotational speed value.

15. The unmanned aerial vehicle control center according to claim 8, wherein the unmanned aerial vehicle control center is disposed on a parking apron.

16. The unmanned aerial vehicle control center according to claim 8, wherein the unmanned aerial vehicle control center is a smart mobile device, a laptop or an unmanned aerial vehicle center console.

17. The unmanned aerial vehicle control center according to claim 8, wherein the control center alarm module is a light-emitting device, an audio playback device or a display equipment.

18. An unmanned aerial vehicle alarm method applicable to an unmanned aerial vehicle and an unmanned aerial vehicle control center, comprising:
configuring the unmanned aerial vehicle to read a real-time drive current value and/or a real-time rotational speed value of a motor and to transmit warning related information to the unmanned aerial vehicle control center; and
configuring the unmanned aerial vehicle control center to configure a control center alarm module to conduct a warning according to a warning control signal.

19. The unmanned aerial vehicle alarm method according to claim 18, wherein the unmanned aerial vehicle control center has a motor information database, and the motor information database has a motor initial rotational speed value and a motor initial drive current value.

20. The unmanned aerial vehicle alarm method according to claim 19, wherein the step of configuring the unmanned aerial vehicle to read a real-time drive current value and/or a real-time rotational speed value of a motor and to transmit warning related information to the unmanned aerial vehicle control center comprises:
configuring the unmanned aerial vehicle in flight to read and store the plurality of real-time drive current values and/or the plurality of real-time rotational speed values of the motor;
configuring the unmanned aerial vehicle to land and to transmit the plurality of real-time drive current values and/or the plurality of real-time rotational speed values as the warning related information to the unmanned aerial vehicle control center; and
configuring the unmanned aerial vehicle control center to determine whether to generate an internal warning control signal as the warning control signal according to the warning related information and the motor information database.

21. The unmanned aerial vehicle alarm method according to claim 20, wherein the step of configuring the unmanned aerial vehicle control center to determine whether to generate an internal warning control signal as the warning control signal according to the warning related information and the motor information database further comprises:
configuring the unmanned aerial vehicle control center to generate the internal warning control signal when one of the real-time drive current values generated by the motor at the same rotational speed value is greater than or equal to 120% of the motor initial drive current value and/or when one of the real-time rotational speed values generated by the motor at the same drive current value is less than or equal to 80% of the motor initial rotational speed value.

22. The unmanned aerial vehicle alarm method according to claim 19, wherein the step of configuring the unmanned aerial vehicle to read a real-time drive current value and/or a real-time rotational speed value of a motor and to transmit warning related information to the unmanned aerial vehicle control center comprises:
configuring the unmanned aerial vehicle to read and transmit the real-time drive current value and/or the real-time rotational speed value of the motor when taking off and hovering as the warning related information to the unmanned aerial vehicle control center; and
configuring the unmanned aerial vehicle control center to determine whether to generate an internal warning control signal according to the warning related information and the motor information database.

23. The unmanned aerial vehicle alarm method according to claim 22, wherein the step of configuring the unmanned aerial vehicle control center to determine whether to generate an internal warning control signal according to the warning related information and the motor information database further comprises:
when the determination is no, configuring the unmanned aerial vehicle in flight to transmit the real-time drive current value and/or the real-time rotational speed value read in real time as the warning related information to the unmanned aerial vehicle control center; and
configuring the unmanned aerial vehicle control center to determine whether to generate the internal warning control signal as the warning control signal according to the warning related information and the motor information database.

24. The unmanned aerial vehicle alarm method according to claim 22, wherein the step of configuring the unmanned aerial vehicle control center to determine whether to generate the internal warning control signal as the warning control signal according to the warning related information and the motor information database further comprises:
configuring the unmanned aerial vehicle control center to generate the internal warning control signal when the real-time drive current value generated by the motor at the same rotational speed value is greater than or equal to 120% of the motor initial drive current value and/or when the real-time rotational speed value generated by the motor at the same drive current value is less than or equal to 80% of the motor initial rotational speed value.

25. The unmanned aerial vehicle alarm method according to claim 23, wherein the step of configuring the unmanned aerial vehicle control center to determine whether to generate the internal warning control signal as the warning control signal according to the warning related information and the motor information database further comprises:
configuring the unmanned aerial vehicle control center to generate the internal warning control signal when the real-time drive current value generated by the motor at the same rotational speed value is greater than or equal to 120% of the motor initial drive current value and/or when the real-time rotational speed value generated by the motor at the same drive current value is less than or equal to 80% of the motor initial rotational speed value.

26. The unmanned aerial vehicle alarm method according to claim 18, wherein the unmanned aerial vehicle has a motor information database, and the motor information database has a motor initial rotational speed value and a motor initial drive current value.

27. The unmanned aerial vehicle alarm method according to claim 26, wherein the step of configuring the unmanned aerial vehicle to read a real-time drive current value and/or a real-time rotational speed value of a motor and to transmit warning related information to the unmanned aerial vehicle control center comprises:
configuring the unmanned aerial vehicle to read the real-time drive current value and/or the real-time rotational speed value of the motor when taking off and hovering, to compare the real-time drive current value and/or the real-time rotational speed value with the motor information database and to determine whether to generate an unmanned aerial vehicle warning control signal and/or an external warning control signal; and
when the determination is yes, transmitting the external warning control signal, the real-time drive current value, and/or the real-time rotational speed value as the warning related information to the unmanned aerial vehicle control center, configuring the unmanned aerial vehicle control center to refer the external warning control signal as the warning control signal, and/or configuring the unmanned aerial vehicle to operate according to the unmanned aerial vehicle warning control signal.

28. The unmanned aerial vehicle alarm method according to claim 27, wherein the step of configuring the unmanned aerial vehicle to read the real-time drive current value and/or the real-time rotational speed value of the motor when taking off and hovering, to compare the real-time drive current value and/or the real-time rotational speed value with the motor information database and to determine whether to generate an unmanned aerial vehicle warning control signal and/or an external warning control signal further comprises:
when the determination is no, configuring the unmanned aerial vehicle in flight to read the real-time drive current value and/or the real-time rotational speed value and to compare the real-time drive current value and/or the real-time rotational speed value with the motor information database to determine whether to generate the unmanned aerial vehicle warning control signal and/or the external warning control signal.

29. The unmanned aerial vehicle alarm method according to claim 27, wherein the step of configuring the unmanned aerial vehicle to compare the real-time drive current value and/or the real-time rotational speed value with the motor information database to determine whether to generate the unmanned aerial vehicle warning control signal and/or the external warning control signal comprises:
configuring the unmanned aerial vehicle to generate the unmanned aerial vehicle warning control signal and/or the external warning control signal when the plurality of real-time drive current values generated by the motor at the same rotational speed value is greater than or equal to 120% of the motor initial drive current value and/or when the plurality of real-time rotational speed values generated by the motor at the same drive current value is less than or equal to 80% of the motor initial rotational speed value.

30. The unmanned aerial vehicle alarm method according to claim 28, wherein the step of configuring the unmanned aerial vehicle to compare the real-time drive current value and/or the real-time rotational speed value with the motor information database to determine whether to generate the unmanned aerial vehicle warning control signal and/or the external warning control signal comprises:
configuring the unmanned aerial vehicle to generate the unmanned aerial vehicle warning control signal and/or the external warning control signal when the plurality of real-time drive current values generated by the motor at the same rotational speed value is greater than or equal to 120% of the motor initial drive current value and/or when the plurality of real-time rotational speed values generated by the motor at the same drive current value is less than or equal to 80% of the motor initial rotational speed value.

31. The unmanned aerial vehicle alarm method according to claim 27, wherein the unmanned aerial vehicle stores the plurality of real-time drive current values and/or the plurality of real-time rotational speed values.
